(19) United States
(12) Patent Application Publication
(10) Pub. No.: US 2005/0278462 A1
(43) Pub. Date: Dec. 15, 2005

(54) Wireless home entertainment interconnection and control system and method

(76) Inventor: Vandy L. Gillespie, Noblesville, IN (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/868,283

(22) Filed: Jun. 14, 2004

(51) Int. Cl. G06F 13/10

(52) U.S. Cl. 710/8

(57) ABSTRACT

An interconnect control unit configures the interconnection of audio-video electronic components. The interconnect control unit receives component data from audio-video electronic components proximate the control unit and generates configuration data from the received component data. The configuration data includes data to configure each electronic component to communicate with at least one other electronic component.

### BACKGROUND OF THE INVENTION

A typical home entertainment or home theatre system includes a television, a digital video disc (DVD) player, an audio video receiver, speakers including a subwoofer, and a remote control. Other components such as a video cassette recorder (VCR) and compact disc (CD) player may also be included. These types of systems are becoming increasingly popular in homes to provide people with an audio video experience that is similar to that of a movie theater. Relatively inexpensive systems provide experiences that are far superior to a standard television.

To install a home theater system, the desired components are purchased and then positioned in a desired room in a person's house, with the position of each component relative to the other components typically being based upon manufacturer's recommendations for optimum performance of the system. For example, the television is typically positioned along one wall of the room along with the audio video receiver, front center speaker, and left and right front speakers. Surround sound speakers are typically positioned on a back wall of the room opposite the front wall, and a subwoofer is positioned either adjacent the front or back wall.

These components are not of course merely positioned in the locations discussed above, but must be interconnected to operate properly. Wires are connected to each component and then routed to the required other components to achieve the required interconnections. This interconnection of the components includes two aspects, a functional aspect and an aesthetic aspect. First, a person must determine the required interconnections between components in order for the components to properly function, which corresponds to the functional aspect. Depending upon a person's comfort level with technology, this may present a daunting task to some individuals.

Once the required interconnections have been determined, the person is faced with the aesthetic aspect of the interconnection: where to physically locate the wires that interconnect the components. The wires physically interconnecting components may be quite large, such as large gauge speaker wires, and regardless of their size are not typically aesthetically pleasing and thus ideally concealed. Due to the physical location of components throughout the room, however, it is not always easy to conceal the interconnecting wires. For example, wires must be routed from the audio video receiver on the front wall to the rear surround sound speakers on the back wall and possibly to the subwoofer is well. This routing of wires is many times a difficult task, requiring wires be routed through walls or under floors or carpets in order to adequately conceal the wires.

There is a need for a system and method of more easily interconnecting audio video components in a home theater system or in any audio video system, such as an audio video system in a business conference room.

### SUMMARY OF THE INVENTION

According to one aspect of the present invention, an interconnect control unit configure the interconnection of audio-video electronic components. The interconnect control unit receives component data from audio-video electronic components proximate the control unit and generates configuration data from the received component data. The configuration data includes data to configure each electronic component to communicate with at least one other electronic component.

### BRIEF DESCRIPTION OF THE DRAWINGS

FIG. 1 is a functional block diagram of a home theater system including a master interconnect control unit according to one embodiment of the present invention.

FIG. 2 is a more detailed front view of a remote control of FIG. 1 according to one embodiment of the present invention.

FIG. 3 is a front view of the remote control of FIG. 2 illustrating an example of manual reconfiguration of components in the system of FIG. 1 using the remote control to modify a default or previous configuration.

### DETAILED DESCRIPTION OF PREFERRED EMBODIMENTS

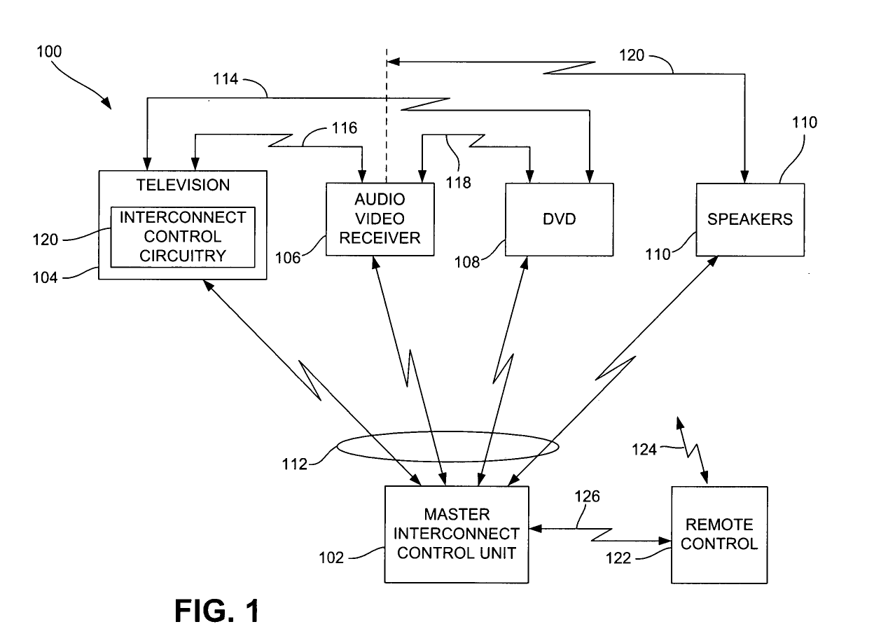

FIG. 1 is a functional block diagram of a home theater system 100 including a master interconnect control unit 102 according to one embodiment of the present invention. In operation, the master interconnect control unit 102 detects the presence of audio video components proximate the control unit and configures these detected components to properly communicate with each other through assigned wireless communications channels, as will be described in more detail below. In this way, the master interconnect control unit 102 automatically handles both the functional and an aesthetic aspects associated with interconnecting components in a home theater system. More specifically, whenever a component is brought proximate the master interconnect control unit 102 the control unit automatically detects the presence of the component and configures the component to properly communicate with the required other components in the system 100. This addresses the functional aspect of interconnecting components while the wireless communications channels assigned to each component addresses the aesthetic aspect since no physical wires are required to interconnect the components.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention.

The home theater system 100 further includes a television 104, an audio video receiver 106, a DVD player 108, and speakers 110 that communicate with the master interconnect control unit 102 over a wireless communications channel 112. The wireless communications channel 112 is depicted as individual links between the control unit 102 and the components 104-110 to illustrate that the control unit communicates with each component. The television 104, audio video receiver 106, DVD player 108, and speakers 110 may be referred to as components 104-110 in the following description to simplify the discussion. Each component 104-110 operates in a conventional manner to provide the corresponding audio and/or video signals and further includes interconnect control circuitry 120 as shown only for the television. In each component 104-110, the interconnect control circuitry 120 communicates with the master interconnect control unit 102 to configure the component to communicate with other components in the system 100, as will be explained in more detail below.

In operation, when one of the components 104-110 is positioned proximate the master interconnect control unit 102 the control unit detects the presence of this component. The control unit 102 may do this in a variety of different ways. In one embodiment, the control unit 102 periodically transmits a query signal over the wireless communications channel 112. In response to the query signal, the interconnect control circuitry 120 in each component 104-110 transmits corresponding component identification data to the control unit 102 over the wireless communications channel 112. The component identification data may include a variety of different types of information that identify the component 104-110 and enables the control unit 102 to interconnect the component to other components in the system 100, thereby configuring the overall system. For example, in one embodiment the component identification data includes data that uniquely identifies the component 104-110 and which identifies a type of the component, such as whether the component is a DVD player or a television and data about the functionality of that component. The component identification data is analogous to a “.inf” file that is utilized in “plug-and-play” computer systems to automatically interconnect components with the computer system based upon data in the “.inf” file. In sum, the component identification data can include a variety of different types of specific information but overall includes information that enables the control unit 102 to configure the component 104-110 to thereby integrate the component into the system 100.

The control unit 102 utilizes the component identification data received from the components 104-110 over the wireless communications channel 112 to configure the overall system 100. More specifically, the control unit 102 processes the received component identification data from the components 104-110 to generate configuration data for each of the components. The configuration data includes parameters that define for each component 104-110 a wireless communications channel or channels over which the component communicates audio and/or video data to other components. Once the configuration data for each component 104-110 has been generated, the control unit 102 communicates the configuration data over the wireless communications channel 112 to the component. The interconnect control circuitry 120 in each component 104-110 receives the configuration data, determines whether the data is directed to that component, and if so configures the circuitry to communicate over the defined wireless channel or channels with the corresponding components.

FIG. 1 illustrates several wireless communications channels 114-120 defined among the components 104-110 in response to configuration data generated by the control unit 102. In response to configuration data from the control unit 102, the interconnect control circuitry 120 in the television is configured to receive video data over a first communications channel 114 from the DVD player 108 and to receive audio data from the receiver 106 over a second communications channel 116. The configuration data supplied to the DVD player 108 and receiver 106 similarly configure these components to communicate the required data over the wireless communications channels 114, 116. The configuration data for the DVD player 108 also configures the DVD player to communicate audio data over a communications channel 118 to the receiver 106 and configuration data supplied to the receiver configures the receiver to receive this audio data. Finally, configuration data for the receiver 106 and speakers 110 defines a communications channel 120 over which the receiver communicates audio data to the speakers.

By configuring the components 104-110 to communicate through the communications channels 114-120, the control unit 102 thereby automatically interconnects the components to properly operate merely upon the components being positioned proximate the control unit. This eliminates the need to physically route wires between such components 104-110 and the need to determine how to properly interconnect the components, and also eliminate the unsightly wires required to interconnect conventional audio video components. Moreover, new components may be easily added to the system 100 simply by connecting power to the new component and positioning the component proximate the control unit 102. For example, assume a CD player (not shown) is purchased and is taken out of its box and plugged in physically adjacent the receiver. The control unit 102 detects the CD player and receives configuration data from the CD player, and thereafter generates new configuration data for each of the components 104-110 to properly interconnect the components. This may, for example, result in the configuration data for the television 104, a DVD player 108, and speakers 110 remaining unchanged while the receiver 106 is reconfigured to establish another communications channel for communicating audio data between the receiver and the CD player.

The system 100 further includes a remote control 122 that may be utilized to control the components 104-110 via a wireless communications channel 124. Additionally, the remote control 122 communicates with the master interconnect control unit 102 over a wireless communications channel 126 to manually adjust the configuration of the components 104-110 as desired. In one embodiment, the remote control 22 also receives remote configuration data from the control unit 102 over the communications channel 126, with this data containing information about the components 104-110 to be controlled in the system 100. In response to the remote configuration data, the remote control 122 configures itself to allow a user to remotely control the components 104-110 contained in the system 100. The remote configuration data can include all information required to enable the remote control 122 to communicate with the components 104-110, eliminating the need to manually train or configure the remote control 122 to communicate with the components, as will be described in more detail below.

In another embodiment of the system 100, instead of the control unit 102 occasionally transmitting the query signal over the wireless communications channel 112, each component 104-110 occasionally transmits the corresponding component identification data to the control unit. In response to the received identification data, the control unit 102 determines whether any changes to the configuration of the system 100 are necessary, such as when a new component is introduced, and reconfigures components 104-110 as required. Also note that any suitable wireless communications protocols may be used in the system 100 and that the description of the various communications channels 112-120 between components in FIG. 1 is functional in that it is intended to illustrate how data is communicated between components. The specific overall communication architecture defined by these communications channels 112-120 may accordingly vary. Thus, for example, each component 104-110 could communicate with the control unit 102 over a separate communications channel at, for example, a different frequency. Alternatively, data transmitted by each of the components 102-110 could be broadcast and received by each component, with each component determining whether the data is directed to that component.

In a further embodiment of the system 100, instead of the communications channels 112-120 being wireless these channels correspond to a physical bus interconnecting the components. For example, new homes may include such a communications bus routed through the walls with ports for coupling to the bus accessible on the various walls of rooms in the house. In this embodiment, with ports for coupling components on the front wall of the room and the same on the back wall, all components 102-110 can be interconnected through the bus routed in the wall of the room. In such an embodiment, the control unit 102 operates in the same way to configure the components 104-110 except the communication is over the bus. Once configured, the components 104-110 may then communicate audio and video data with each other either over defined wireless communications channels or over the bus. While such an embodiment may be more limiting relative to the wireless embodiment as far as physically locating the components 104-110 goes, automatic interconnection of components is still provided as is automatic interconnection for newly added components. In this embodiment, the components 104-110 or any other component may be considered to be “proximate” the control unit 102 whenever the component is connected to the physical bus.

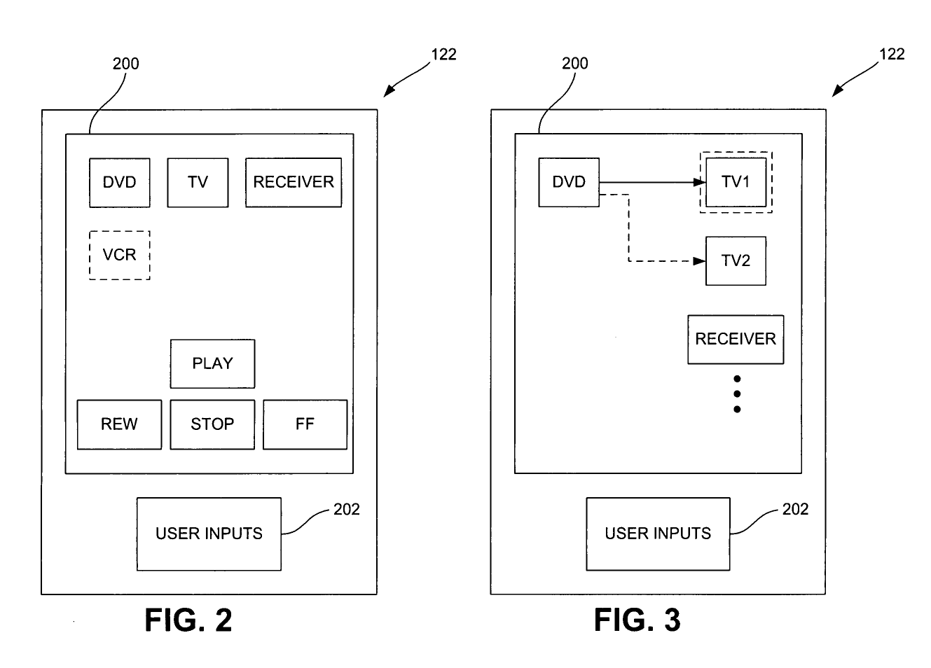

FIG. 2 is a more detailed front view of the remote control 122 of FIG. 1 according to one embodiment of the present invention. The remote control 122 includes a touch screen 200 on which the remote control displays buttons and possibly other desired information to allow a user to control the components 104-110 of FIG. 1. On the touch screen 200, the remote control 122 utilizes the remote configuration data to generate the required buttons. For example, in the system 100 of FIG. 1 the remote configuration data indicates the components include the television 104, receiver 106, DVD player 108, and speakers 110. The touch screen 200 then includes the appropriate buttons to allow a user to control each of these components 104-110. For example, when a user wants to control the DVD player 108 the touch screen 200 displays buttons such as menu, chapter selection, play, fast forward, rewind, and so on to allow the user to control the DVD player. The remote control 122 may further include user inputs 202 such as hardware buttons that allow the user to control some of the components 104-110. For example, the user inputs could include a power button that allows the user to turn all components 104-110 on or off with the push of a single button. The remote control 122 utilizes the received remote configuration data to configure itself to perform the desired function responsive to the user inputs 202. The touch screen 200 allow the remote control 122 to be “dynamic” in that as new components are added or removed from the system 100, the buttons on the touch screen may be updated accordingly.

As previously mentioned, the remote control 122 communicates with the master interconnect control unit 102 over the wireless communications channel 126 (FIG. 1) to manually adjust the configuration of the components 104-110 as desired. A user may want to do this, for example, when the user wants to change the default configuration generated by the control unit 102 that defines the interconnection of the components 104-110. FIG. 3 is a front view of the remote control 122 of FIG. 2 illustrating an example of manual reconfiguration of components 104-110 in the system of FIG. 1 using the remote control to modify the default configuration. To provide this functionality, the touch screen 200 or the user inputs 202 allow a user to communicate with the control unit 102 to initiate a reconfiguration mode of operation. In operation, the user initiates the reconfiguration mode either using the touch screen 200 or user inputs 202. In response to the user initiating the reconfiguration mode, the touch screen 200 displays information on the touch screen 200 that enables the user to modify the configuration of the components 104-110. For example, perhaps for some reason a user does not want the DVD player 108 to communicate audio data to the receiver 106 but only to the television 104. In this case, the user utilizes the remote control 122 to modify the configurations of the television 104, receiver 106, and the DVD player 108 so that the DVD player communicates audio data only to the television. Once the desired reconfiguration is complete, the user exits the reconfiguration mode and the remote control 122 communicates the configuration changes to the control unit 102 which, in turn, communicates to the required components 104-110 to reconfigure the components as required.

FIG. 3 illustrates another example of a situation where the user may want to reconfigure components 104-110. Suppose that the user is watching a movie being played by the DVD player 108 on the television 104 which is located in a downstairs family room. Then suppose the user wants to go to bed but would like to continue watching the same movie on a second television in his bedroom, but the user only has the single DVD player 108. All the user need do is to first provide appropriate inputs to the remote control 122 to enter the reconfiguration mode of operation. In response to entering the reconfiguration mode, the touch screen 200 displays configuration information on the touch screen 200 as illustrated in FIG. 3. In this example, the configuration information on the touch screen 200 shows the DVD player 108 being interconnected to the television 104 via an arrow 300, with the television 104 being designated TV1. Now suppose the television in the user's bedroom is designated TV2 as shown on the touch screen 200. The user provides inputs through suitable control buttons on the remote control 122 to select TV2 instead of TV1. In FIG. 3, the television TV1 is shown as being selected by a dotted line around TV1 while TV2 is unselected. Once the user selects TV2, the dotted line would appear around TV2. The user would then go to his or her bedroom and watch the remainder of the movie. In this example, the television TV2 is of course part of the network 100 and when initially placed in the user's bedroom would be detected and configured by the master control unit 102 in order to provide this functionality.

Although the example of FIG. 3 shows reconfiguration being done on the remote control 122, in another embodiment reconfiguration is done using a configuration menu displayed on the television 104 in much the same way configuration of DVD players or VCRs is currently done. In this embodiment, when the user initiates the reconfiguration mode of operation using the remote control 122, appropriate menus are displayed on the television 104 to allow the user to reconfigure the components 104-110. In this embodiment, the remote control 122, control unit 102, and television 104 operate in combination as required to allow reconfiguration of the components 104-110 via configuration menus displayed on the television.

Even though various embodiments and advantages of the present invention have been set forth in the foregoing description, the above disclosure is illustrative only, and changes may be made in detail and yet remain within the broad principles of the present invention. Moreover, the functions performed by the master interconnect control unit 102, interconnect control circuitry 120, and remote control 122 can be separated and performed by more elements or combined into different functional blocks depending upon the specific embodiment of the system 100, as will appreciated by those skilled in the art. Therefore, the present invention is to be limited only by the appended claims.

1. An interconnect control unit for configuring interconnection of audio-video electronic components, the interconnect control unit operable to receive component data from audio-video electronic components proximate the control unit and operable to generate configuration data from the received component data, the configuration data including data to configure each electronic component to communicate with at least one other electronic component.

2. The interconnect control unit of claim 1 wherein the interconnect control unit is further operable to occasionally generate a query signal and to receive the component data from each audio-video electronic component responsive to the component receiving the query signal.

3. The interconnect control unit of claim 1 wherein the control unit is further operable responsive to receiving component data from a new audio-electronic component to generate new configuration data to reconfigure at least some of the audio-video electronic components.

4. The interconnect control unit of claim 1 wherein the interconnect control unit generates configuration data including parameters for a plurality of wireless communications channels, the parameters including data to establish respective communications channels between pairs of electronic components for communicating audio and/or video data between the components.

5. The interconnect control unit of claim 1 wherein the interconnect control unit is operable to receive configuration data from electronic components proximate the control unit through a wireless communication channel.

6. The interconnect control unit of claim 1 wherein the interconnect control unit is further operable to receive manual configuration data and operable responsive to the manual configuration data to generate new configuration data to reconfigure at least some of the audio-video electronic components.

7. The interconnect control unit of claim 1 wherein the electronic components comprise at least one of a television, a digital video disc player, a compact disc player, a stereo receiver, and audio speakers.

8. The interconnect control unit of claim 1 wherein the interconnect control unit is further operable to communicate configuration data over a wireless communications channel to each audio-video electronic component, the configuration data containing data the receiving component utilizes to define parameters of a communications channel with at least one other electronic component.

9. An audio-video electronic component including interconnect control circuitry operable to communicate audio and/or video data over a communications channel, the control circuitry further operable to provide component data indicating characteristics of the component and adapted to receive configuration data when proximate a certain location, and the interconnect control circuitry operable to configure the communications channel using the configuration data.

10. The audio-video electronic component of claim 9 wherein the interconnect control circuitry is operable to communicate the audio and/or video data over a wireless communications channel.

11. The audio-video electronic component of claim 10 wherein the interconnect control circuitry is further operable to provide the component data and receive the configuration data over a wireless communications channel.

12. The audio-video electronic component of claim 9 wherein the interconnect control circuitry is further adapted to receive a query signal and is operable to provide the component data responsive to the query signal.

13. The audio-video electronic component of claim 9 wherein the electronic component comprises one of a television, a digital video disc player, a compact disc player, a stereo receiver, and an audio speaker.

14. An audio-video connection and control system, comprising:
a plurality of audio-video components, each audio-video component operable to provide component data over a corresponding communications channel and adapted to receive configuration data, the device being operable to define a communications channel with another component responsive to the received configuration data; and
an interconnect control unit for configuring interconnection of audio-video electronic components, the interconnect control unit operable to receive component data from audio-video electronic components proximate the control unit and operable to generate configuration data from the received component data and to provide the configuration data to the audio-video electronic components to configure the components to communicate with each other.

15. The audio-video connection and control system of claim 14 further comprising a remote control unit operable to communicate with audio-video electronic components to control the components during a normal operation mode of operation.

16. The audio-video connection and control system of claim 15 wherein the remote control unit is further adapted to receive manual configuration data inputs and operable to generate manual configuration data signals responsive to the manual configuration data inputs, and wherein the interconnect control unit is further operable to receive the manual configuration signals and to reconfigure the audio-video electronic components to communicate with each other responsive to the manual configuration signals.

17. The audio-video connection and control system of claim 16 wherein the remote control unit further comprises a plurality of buttons, the buttons being operable to allow a user to provide the manual configuration data inputs.

18. The audio-video connection and control system of claim 17 wherein the remote control unit further comprises a touch screen display that is operable to display the plurality of buttons.

19. The audio-video connection and control system of claim 14 wherein the electronic components comprise at least one of a television, a digital video disc player, a compact disc player, a stereo receiver, and audio speakers.

20. The audio-video connection and control system of claim 14 wherein the interconnect control unit is further operable to communicate configuration data over a wireless communications channel to each audio-video electronic component, the configuration data containing data the receiving component utilizes to define parameters of a communications channel with at least one other electronic component.

21. The audio-video connection and control system of claim 14 wherein the interconnect control unit is further operable to occasionally generate a query signal and wherein each audio-video electronic component is operable to provide the corresponding component data responsive to the query signal.

22. A method of interconnecting audio-video electronic components, the method comprising:
detecting audio-video electronic components to be interconnected;
determining characteristics of the detected audio-video components;
from the determined characteristics, defining wireless communications channels between pairs of components over which audio and/or video data is to be communicated; and
configuring each of the components to communicate audio and/or video data over the corresponding defined wireless communications channel to thereby interconnect the components.

23. The method of claim 22 wherein automatically detecting audio-video electronic components to be interconnected comprises detecting components proximate a certain location.

24. The method of claim 22 wherein automatically detecting audio-video electronic components comprises detecting coupling of the components to a wired communications network.
